(19) United States
(12) Patent Application Publication
(10) Pub. No.: US 2003/0024948 A1
(43) Pub. Date: Feb. 6, 2003

(54) System for dispensing a liquid or pasty substance from a bag

(75) Inventor: Laurens Last, Monte Carlo (MC)

Correspondence Address: HOFFMANN & BARON, LLP, 6900 JERICHO TURNPIKE, SYOSSET, NY, 11791, US

(73) Assignee: Itsac N.V., Curacao (AN)

(21) Appl. No.: 10/191,003

(22) Filed: Jul. 8, 2002

Related U.S. Application Data
(63) Continuation of application No. PCT/NL01/00004, filed on Jan. 4, 2001.

(30) Foreign Application Priority Data
Jan. 7, 2000 (NL) 1014039
Dec. 13, 2000 (NL) 1016866

(51) Int. Cl. B67D 5/60

(52) U.S. Cl. 222/103; 222/145.6; 222/207; 222/214; 222/145.5

(57) ABSTRACT

A system for providing portions of a substance, in particular a liquid or pasty substance, includes a bag filled with the substance which is to be dispensed, a storage chamber for holding a store of substance which is to be dispensed being delimited in the bag, which store includes a plurality of portions, preferably a large number of portions, of the substance which is to be dispensed, and a dispensing chamber which can be connected to the storage chamber via a connection in the bag also being delimited in the bag, and the bag being provided, at the dispensing chamber, with an outlet opening for dispensing the substance from the bag, a dispensing device which has a housing in which there is a space for accommodating the bag, which space includes a section for accommodating the storage chamber of the bag and a section for accommodating the dispensing chamber of the bag, the system being designed to supply in each case one or a few portions of the substance to the dispensing chamber from the storage chamber, the dispensing device including heat-transfer means for influencing the temperature of the substance. The dispensing device is provided, at the section for the dispensing chamber, with heat-transfer means for influencing the temperature of the substance which is to be dispensed from the dispensing chamber with respect to the temperature at which the substance passes from the storage chamber into the dispensing chamber.

### CROSS-REFERENCE TO RELATED APPLICATIONS

The present application is a continuation of PCT/NL01/00004, filed Jan. 4, 2001, which claims priority to Dutch patent application number 1014039, filed Jan. 7, 2000, and Dutch patent application number 1016866, filed Dec. 13, 2000, all of which are incorporated herein by reference.

### FIELD OF THE INVENTION

According to a first aspect, the present invention relates to a system according to the preamble of claim 1 and to a dispensing device according to the preamble of claim 34. A system of this type and a dispensing device of this type are known, for example, from WO 97/33809.

In the known system, the storage chamber of the bag is pressed empty by movable plates of the dispensing device, which plates are heatable. In this way, it is possible, with the known system, to dispense portions of substance at a desired elevated dispensing temperature, the whole of the store of the substance in the bag being heated to this elevated dispensing temperature.

The known system is suitable for many kinds of substances but nevertheless has undesirable drawbacks. These drawbacks will be explained in more detail below on the basis of the example of drinking chocolate.

Nowadays, there is a demand in the catering industry for hot drinking chocolate, so that consideration may be given to using the known system for this product.

A first drawback which has emerged is that because the store of drinking chocolate is heated, there is a high risk of bacterial contamination, and consequently the shelf life is very limited. If there is a low demand, this means that drinking chocolate would have to be thrown away with undesirable frequency.

A second drawback, in particular when the known system is used in the catering industry, is that after a new bag has been placed in the dispensing device a long heating time is required in order to bring the store in the bag up to the desired elevated dispensing temperature. The fact that the capacity of the heating plates to emit heat is limited if the electric heating system thereof is to be connected to the lighting mains, which is the preferred option, plays a role in this.

A third drawback is that a product such as drinking chocolate, after a period of time has elapsed, is no longer sufficiently homogeneous, so that, for example, the composition changes as the bag is emptied to an increasing extent. The latter drawback also applies, incidentally, to a wide range of substances, such as paint, soup, etc., and is not restricted to substances which have to be heated.

### SUMMARY OF THE INVENTION

One object of the invention is to provide an improved system for dispensing a liquid or pasty substance from a bag, by means of which one or more of the abovementioned drawbacks can be eliminated.

Another object of the invention is to provide a system with an efficient heating or cooling of the substance which is to be dispensed.

Yet another object of the invention is to provide a system in which the risk of contamination to the store of substance is minimized, in particular if this substance is dispensed in the heated state.

A further object of the invention is to provide a system in which the time required to heat or cool the substance to be dispensed is short.

Yet another object of the invention is to provide a system in which the dispensing of a substance from a bag is possible even if this substance is so thick that it scarcely flows at the desired dispensing temperature.

Yet another object of the invention is to provide a system for dispensing portions of a liquid or pasty substance which is suitable for human consumption, for example a dairy product, a (pasta) sauce, soup, an (alcoholic) drink, etc.

Yet another object is to provide a system in which (edible) substances which are susceptible to losing homogeneity at elevated temperature can be dispensed without problems in the heated state.

Yet another object is to provide a system in which portions of the substances which are each at a different temperature can be dispensed successively within a short period of time.

A further object of the invention is to provide a dispensing device and a bag which is suitable for use in a system of this type.

According to a first aspect, the invention provides a system according to the preamble of claim 1 and a dispensing device according to the preamble of claim 34 which are characterized in that the dispensing device, at the section of the space inside it which is to hold the dispensing chamber of the bag, is provided with heat-transfer means for influencing the temperature of the substance which is to be dispensed from the dispensing chamber with respect to the temperature at which the substance passes from the storage chamber into the dispensing chamber, which heat-transfer means are designed to supply heat to substance present in the dispensing chamber of the bag or to extract heat from substance present in the dispensing chamber of the bag, in such a manner that a portion of substance can be dispensed at a desired dispensing temperature from the dispensing chamber.

In other words, the invention provides for the substance to be brought to a desired dispensing temperature in the dispensing chamber in the bag and not in the storage chamber of the bag.

The invention makes it possible for the substance in the storage chamber to be kept at a different temperature from the desired dispensing temperature. With this measure, it is easily possible, for example, to avoid the abovementioned problem of bacterial contamination. By way of example, it is possible to provide for the substance in the storage chamber to be cooled or not heated, while the substance in the dispensing chamber is heated and can be dispensed at an elevated dispensing temperature. By way of example, the dispensing temperature of the substance can be set between 20 and 100° C.

The system can be used for a wide range of substances. Advantageously, the substance is a foodstuff which is intended for human consumption, in particular a perishable foodstuff. The bag is preferably then filled with the substance under aseptic conditions. If the substance is then dispensed in the heated state, it is possible to provide for the dispensing temperature to be between 60 and 95° C.

The invention also provides for the possibility of dispensing the substance at a low temperature, i.e. in cooled form, in which case the dispensing temperature of the substance can be set, for example, between −5 and 15° C. Examples of possible applications are in this case iced tea or an alcoholic drink which it is desired to consume at a low temperature. In that case, substance in the storage chamber does not have to be cooled.

The measure according to the invention also offers the option of dispensing a substance from a bag which has difficulty flowing at room temperature. If the substance is then heated in the storage chamber, its viscosity can be reduced, making it easier to feed it to the dispensing chamber of the bag and leading to reduced residues in the bag, while if appropriate the portion to be dispensed can be cooled again in the dispensing chamber in order to reach the desired dispensing temperature.

The measures according to the first aspect of the invention also make it possible to solve the problem of the long heating time, since in principle it could be sufficient to accommodate a single portion of the substance in the dispensing chamber, so that the heat exchange with this portion of substance can be realized very quickly.

In a preferred embodiment, the system is designed in such a manner that—to achieve rapid heat transfer to the substance—a thin layer of the substance with a large area is present in the dispensing chamber.

The maximum volume of the dispensing chamber may be restricted to a single portion which is to be dispensed, but it is also possible for the dispensing chamber of the bag to have a maximum volume which is such that a plurality of portions of the substance can be accommodated therein, the volume of the dispensing chamber being smaller than that of the storage chamber.

The dispensing device is preferably provided with actuable closure means for closing off the connecting passage in the bag, so that there cannot be any undesirable flow of the substance back out of the dispensing chamber to the storage chamber. In combination or as an alternative, the bag itself could be provided with closure means, for example with a non return valve action, which are designed to close off the storage chamber and dispensing chamber from one another, in particular in order to prevent undesirable flow back from the dispensing chamber to the storage chamber.

According to a second aspect, the invention relates to a system according to claim 35, which system provides a possible solution to the problem of the inhomogeneity of the substance in the bag. This problem occurs with a wide range of products, such as foodstuffs but also, for example paint products.

It will be clear that the first and second aspects of the invention may advantageously also be used in combination.

Finally, a third aspect of the invention provides a bag according to claim 36, which bag, in a suitable embodiment, can be used in the above-described system according to the invention, but also for entirely different purposes.

### BRIEF DESCRIPTION OF THE DRAWINGS

Further advantageous embodiments of the system according to the invention, as well as application examples thereof, and the bag according to the third aspect of the invention are described in the claims and the following description with reference to the drawing, in which:

FIG. 1 diagrammatically depicts a perspective view of an exemplary embodiment of a dispensing device according to the invention,

FIG. 2 diagrammatically depicts a perspective view of a substance-filled bag of the system according to the invention,

FIG. 3 diagrammatically depicts a perspective view of part of the device shown in FIG. 1, with the bag shown in FIG. 2 accommodated therein,

FIG. 4 diagrammatically depicts a perspective view of another part of the device shown in FIG. 1,

FIGS. 5-8 diagrammatically depict front views of that section of the device which is shown in FIG. 3, in different states,

FIG. 9 shows a view which corresponds to that shown in FIGS. 5-8 of a variant of the dispensing device with the bag shown in FIG. 2 positioned therein, and

FIG. 10 shows a bag according to the third aspect of the invention.

### DETAILED DESCRIPTION OF THE INVENTION

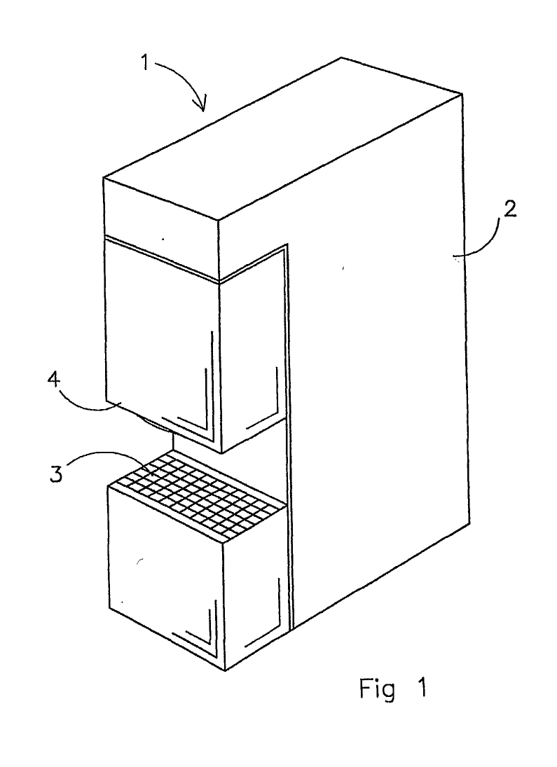

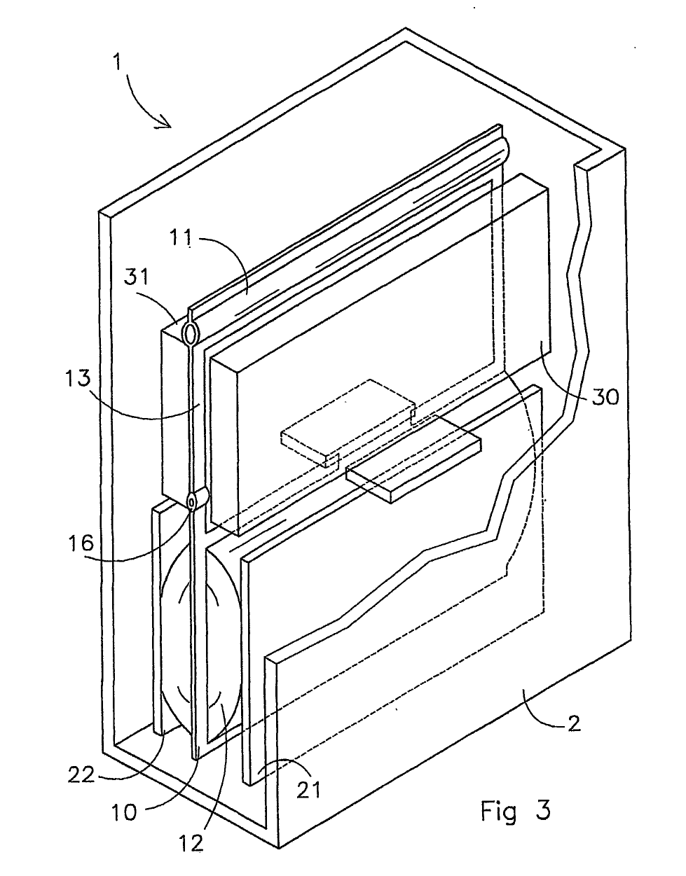

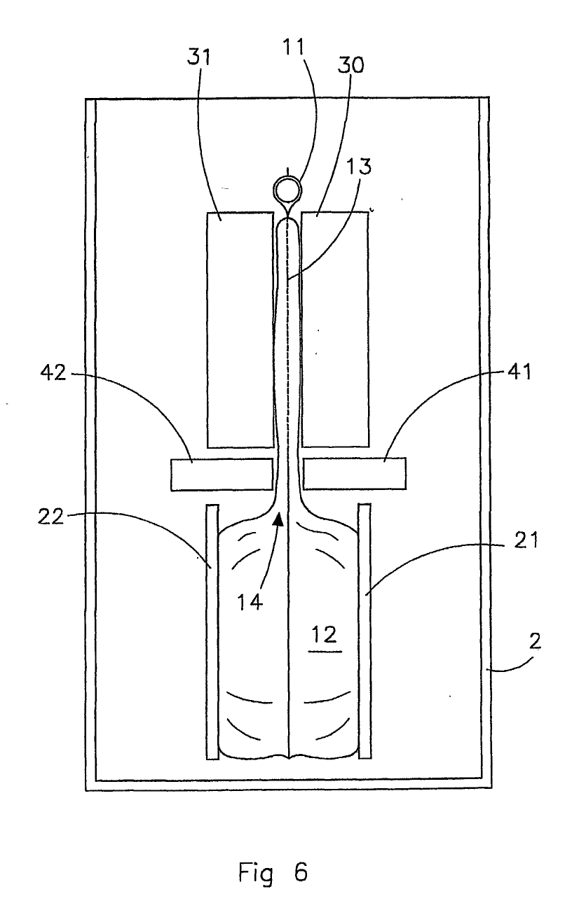

An exemplary embodiment of the system for providing portions of a substance, in this example portions of hot drinking chocolate, will be explained below with reference to FIGS. 1-8.

The system firstly comprises a dispensing device 1, a possible embodiment of which is shown in FIG. 1. The device 1 has a housing 2 with a stand 3 for a container which is to be filled with a portion of hot drinking chocolate. In the housing part 4 above the stand grate 3 there is a dispensing opening, out of which hot drinking chocolate can be dispensed.

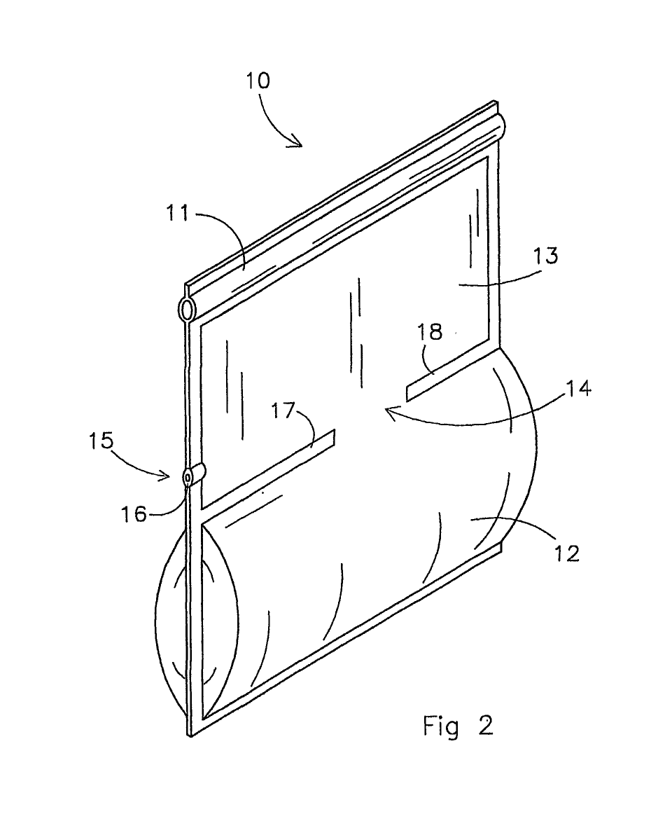

FIG. 2 shows a bag 10 which is filled with drinking chocolate and can be positioned in the dispensing device 1.

The bag 10 is made from a suitable plastics film, for example polyethylene (PE) or polypropylene (PP), in this example by welding together two layers of film. The material of the bag may also be a laminated material. By way of example, the outermost layer is able to withstand elevated temperatures. The bag may also include a layer of metallic material, such as aluminium, in order to ensure the gastightness and airtightness.

In this example, the bag 10 has a hanging feature 1, by means of which the bag 10 can be hung in the device 1. The hanging feature 11 in this case comprises an insertion cavity for a hanging rod which is supported on the housing 2.

At the bottom, the bag 10 has a storage chamber 12 for accommodating a store of drinking chocolate, which store comprises a plurality, preferably a large number, of portions.

The bag preferably contains 5 litres of drinking chocolate.

Furthermore, a dispensing chamber 13 which is connected to the storage chamber 12 via a connecting passage 14 in the bag 10 is delimited in the bag 10.

The maximum volume of the storage chamber 12 is such that all the drinking chocolate which is introduced into the bag 10 by the manufacturer, preferably under aseptic conditions, fits into it, after which the bag 10 is closed. In this example, therefore, the storage chamber 12 can accommodate at least 5 litres.

The bag 10 is preferably filled with the drinking chocolate in such a way that there is no air enclosed in the bag 10.

A portion of hot drinking chocolate usually has a volume of approximately 200 ml.

In this example, the dispensing chamber 13 of the bag 10 has a maximum volume which is a plurality of times greater than the volume of a portion which is to be dispensed. In particular, the dispensing chamber 13 has a maximum volume which is sufficient to accommodate half the total amount of drinking chocolate in the filled and closed bag 10, i.e. of approximately 2.5 litres. The advantage of this will be explained below.

The bag 10 is provided, at the dispensing chamber 13, with an outlet opening 15 for dispensing the drinking chocolate from the bag. For this purpose, a body 16 with a continuous hole is welded into a vertical side seam of the bag 10, a stopper which is able to close off the hole being provided on the inside of the bag.

The connecting passage 14 is in this case a channel formed by welds 17, 18 which are oriented transversely from the side seams and end at a distance from one another. The cross-sectional area of the channel 14 is therefore smaller than the cross-sectional area of both the storage chamber 12 and the dispensing chamber 13.

In a variant, the separation between the dispensing chamber 13 and the storage chamber 12 of the bag 10 which has been placed in the device 1, which separation is formed by the welds 17, 18, does not run horizontally, but rather slopes downwards, preferably towards the outlet opening 15 of the bag 10. Furthermore, the vertical distance between the bottom of the dispensing chamber 13 and opening 15 may be different from, for example greater than, that shown in the drawing, partly on account of its possible influence on the deterioration.

In a variant which is not shown, it is possible for the bag itself not to have a separation between the storage chamber and the dispensing chamber and for the dispensing device to be provided with actuable bag-squeezing means which locally squeeze the bag, in such a manner that a storage chamber and a dispensing chamber, as well as a connecting passage comprising one or more channels between them, are formed in the bag.

In the housing 2, the dispensing device 1 has a space for accommodating the bag 10, which space comprises a bottom or first section for accommodating the storage chamber 12 of the bag and a top or second section for accommodating the dispensing chamber 13 of the bag 10.

In this example, the bottom section of the dispensing device 1 is provided with two compression plates 21, 22 which are arranged at a variable distance from one another, in such a manner that the filled storage chamber 12 of the bag 10 fits between them. Each of the plates 21, 22 has an associated displacement means 23, 24 for varying the distance between the plates 21, 22 so that the storage chamber 12 can be compressed and, in this way, the drinking chocolate can be pushed upwards into the dispensing chamber 13. It will be clear that instead of the compression plates 21, 22 it is also possible to provide another form of compression means for compressing the bag, for example one or more inflatable bellows.

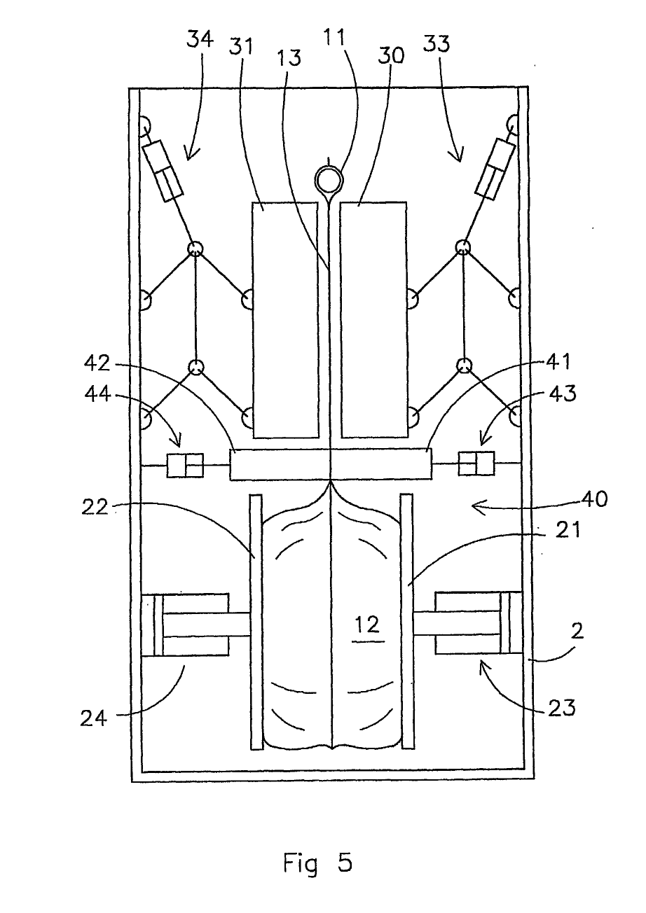

Purely by way of example, FIG. 5 shows pneumatic cylinders as displacement means 23, 24. Naturally, it is also possible to use completely different displacement means.

Heat-transfer means are arranged in the top section of the dispensing device 1, for the purpose of influencing the temperature of, in this example heating, the drinking chocolate in the dispensing chamber 13 with respect to the temperature of the drinking chocolate in the storage chamber 12.

In this example, the heat-transfer means comprise two heat-transfer bodies 30, 31 which are arranged at a variable distance from one another and between which the dispensing chamber 13 of the bag 10 fits.

In this example, the heat-transfer bodies 30, 31 are thick metal, for example aluminium, plates. Each of the plates 30, 31 has an associated electric heating element with thermostatic temperature control (not shown) which is integral with the corresponding plate. In this way, the plates 30, 31 can be brought to and kept at a set elevated temperature, for example a temperature of approximately 100° C.

The plates 30, 31 have a considerable thickness, for example of 20 millimetres, and a large area, with the result that the plates 30, 31 are able to store a considerable amount of heat. In particular, the heat storage capacity of the plates 30, 31 is such that, at the predetermined temperature of the plates 30, 31, a quantity of heat which is sufficient to heat more than one portion of drinking chocolate to a predetermined, desired dispensing temperature within a short time can be exchanged between the drinking chocolate in the dispensing chamber 13 and the corresponding plates 30, 31. By way of example, it is now possible, if a single portion of 200 ml of drinking chocolate at room temperature is introduced into the dispensing chamber 13, for this portion to be heated to approximately 70° C. in less then 20 seconds. The plates 30, 31 act as a buffer store for sufficient heat to heat three such portions of drinking chocolate.

The advantage of storing a considerable quantity of heat in the plates 30, 31 is, inter alia, that the capacity of the associated electric heater elements can remain limited, for example to approximately 2000 watts, so that a standard connection to the 220 V lighting mains is sufficient.

The rapid heating of the drinking chocolate in the dispensing chamber 13 allows the portion to be dispensed rapidly. Furthermore, the rapid heating is advantageous from a bacteriological viewpoint.

The distance between the plates 30, 31 can be varied by means of associated displacement means 33, 34. Purely by way of example, in FIG. 5 these means 33, 34 are designed as a knee lever mechanism with a pneumatic cylinder.

The dispensing device 1 also comprises actuable closure means 40 for selectively closing off the channel 14 in the bag 10. In this example, these closure means 40 comprise two closure members 41, 42 which can move in a reciprocating manner and have associated drive means 43, 44. By moving the closure means 41, 42 towards one another, the bag 10 can be squeezed shut at the location of the channel 14, as shown in FIG. 5.

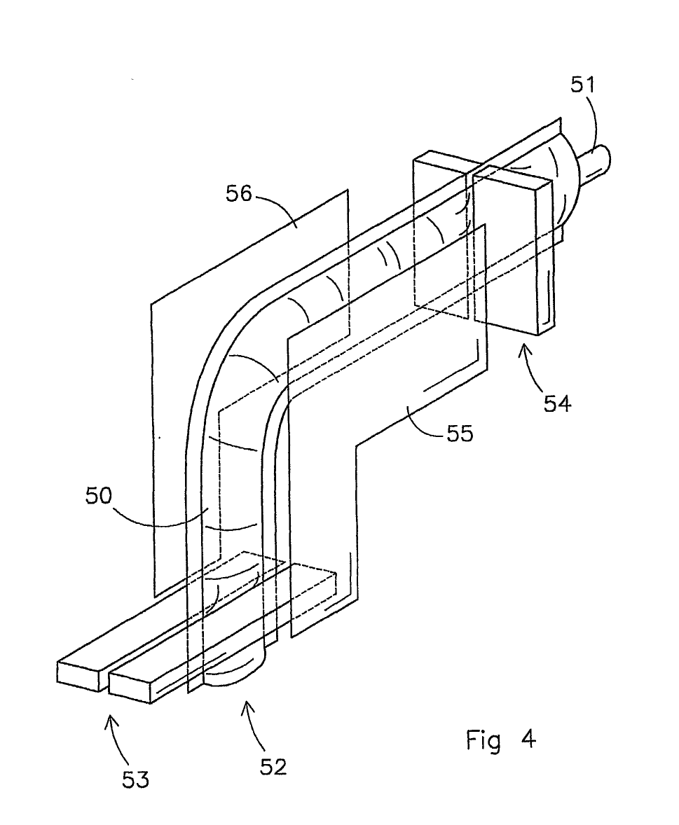

FIG. 4 shows that part of the dispensing device 1 which is positioned in housing part 4 of the device 1. The figure shows a curved, tubular dispensing channel 50 with a male connector part 51 at one end, which can be connected to the body 16 arranged on the bag 10 in order in this way to connect the dispensing chamber 13 of the bag 10 to the channel 50. At the other end, the channel 50 has a dispensing nozzle 52, from which the drinking chocolate is dispensed.

The channel 50 is in this case of compressible design, for example as a flexible hose.

At the dispensing channel 50, the dispensing device 1 is provided with two actuable closure means 53, 54 which are able to close off the channel 50 at locations which are situated at a distance from one another.

Furthermore, as an additional feature, the dispensing device 1 is provided with means for removing drinking chocolate residues from the dispensing channel 50. In this example, two plates 55, 56 are provided for this purpose, which can be pressed towards one another by means of displacement means (not shown), in order in this way to compress the channel 50 and force out the residual drinking chocolate.

In an advantageous embodiment, at least the channel 50 is arranged removably in the device, so that the channel 50 can be cleaned.

The way in which the system described above operates will now be explained in more detail with reference in particular to FIGS. 5-8.

In FIG. 5, the bag 10 is situated in the device 1. In this figure, the dispensing chamber 13 is virtually or completely empty. Furthermore, the channel 14 has been closed by the closure means 40. The plates 30, 31 are at their set temperature of approximately 100°°C. To prevent the plastic of the bag 10 becoming damaged or melting on account of the high temperature of the plates 30, 31, these plates 30, 31 are now not in contact with the dispensing chamber 13 of the bag 10, but rather are at a suitable distance therefrom. If appropriate, a movable insulating screen is temporarily positioned between the plates 30, 31 and the bag 10.

Since the storage chamber 12 which is filled with substance is situated beneath the dispensing chamber 13, the top part of the bag 10 is pulled taut, certainly when the closure means 40 release the bag 10. In the empty state, the dispensing chamber then does not come into contact with the plates 30, 31.

If it is desired for a portion of hot drinking chocolate to be dispensed, the closure means 40 open the channel 14 in the bag 10. The plates 20, 21 are then pressed together, so that the drinking chocolate is pushed upwards and enters the dispensing chamber 13.

At the same time, the plates 30, 31 are moved towards one another slightly, until a thin, gap-like space for the dispensing chamber 13 is delimited between them, in such a manner that only a single portion of drinking chocolate fits into the dispensing chamber 13. By way of example, the distance between the plates 30, 31 is now less than 5 millimetres, and the maximum value used is preferably 1 centimetre. As a result of expansion of the dispensing chamber 13 caused by the filling with drinking chocolate and by the distance between the plates 30, 31, the plates 30, 31 and the walls of the dispensing chamber 13 of the bag 10 come into contact with one another.

On account of the weight of the drinking chocolate in the bottom of the bag 10, the walls of the bag in that part of the dispensing chamber 13 remain taut, so that there are no creases in that part of the bag and there is no inclusion of air between the bag and the plates 30, 31.

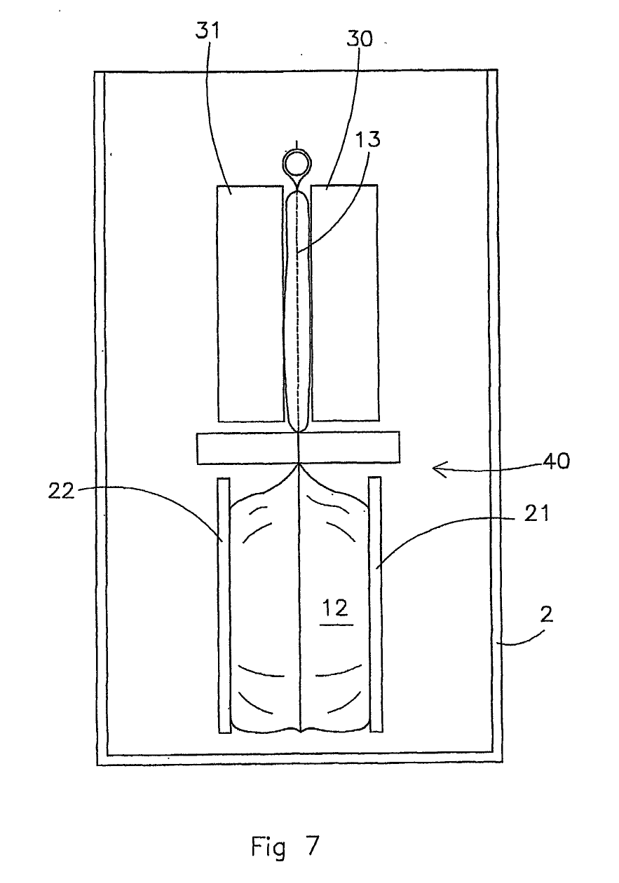

As soon as the dispensing chamber 13 has been filled, the channel 14 is closed off in order to prevent the heat from the plates 30, 31 reaching the drinking chocolate in the storage chamber 12 or heated drinking chocolate from flowing back into the storage chamber 12. This situation is shown in FIG. 7.

Now that the dispensing chamber 13, which has been filled with drinking chocolate, is in contact with the hot plates 30, 31, heat is transferred to the drinking chocolate in the said chamber 13. By way of example, the transfer is maintained for approximately 20 seconds, so that the drinking chocolate in the dispensing chamber 13 can reach the desired dispensing temperature.

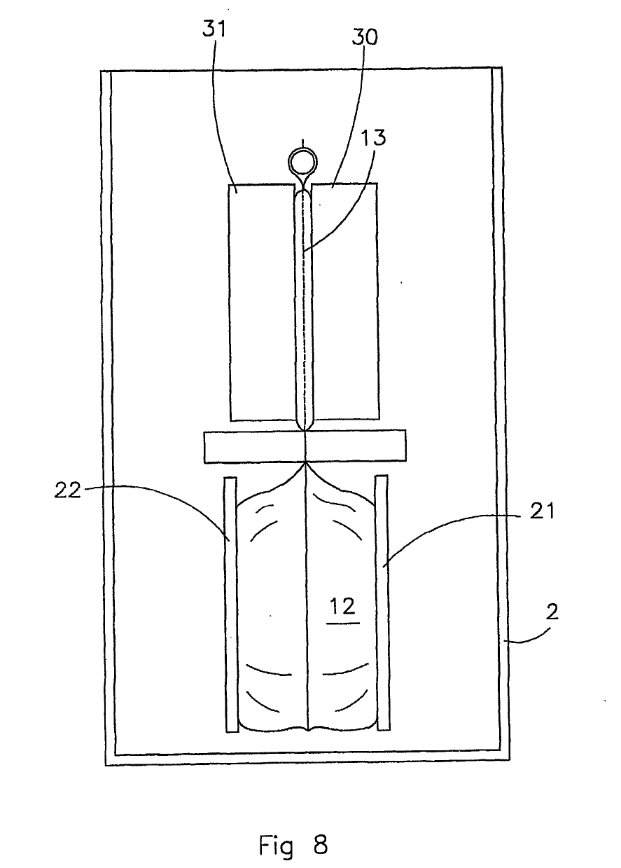

Then, the closure means 53, 54 of the dispensing channel 50 are opened, with the result that the hot drinking chocolate flows out of the dispensing chamber 13. To ensure that the dispensing chamber 13 is completely emptied, which is preferable, the plates 30, 31 are moved towards one another, so that the dispensing chamber 13 is pressed empty, cf. FIG. 8. The plates 30, 31 then move back into their starting position.

To prevent bacterial contamination, it is possible for one or more of the closure means 53, 54, preferably at least the closure means 53 located in the vicinity of the dispensing nozzle, to be provided with heater means which keep the closure means at a sterilization temperature.

Another option for preventing bacterial contamination is to blow the channel 50 empty and dry after a portion has been dispensed.

In connection with the deterioration of the drinking chocolate, it is also advantageous if a superatmospheric pressure is continuously maintained in the storage chamber 12. This prevents contaminants and/or heated drinking chocolate from penetrating into the storage chamber 12. The excess pressure can be produced using the plates 20, 21 or in some other way.

When the dispensing chamber 13 is empty, firstly the closure means 54 closes. Then, the plates 55, 56 press the channel 50 until it is empty, and then the closure means 53 closes. This prevents bacterial contamination in the channel 50.

In the device shown, therefore, the plates 30, 31 have a plurality of functions. Firstly, the plates 30, 31 serve as heat-transfer body in order to emit heat to the drinking chocolate in the dispensing chamber 13 via contact transfer. In the example shown, that surface of the plates 30, 31 which is in contact with the dispensing chamber 13 virtually entirely corresponds to the surface of the walls of the dispensing chamber 13. To enable the heat transfer to take place rapidly, it is preferable for the plates 30, 31 to bear against at least 50% of the surface of the walls of the dispensing chamber of the bag 13.

Secondly, the plates 30, 31 serve as a store for a considerable quantity of heat, so that the associated heater elements only require a limited maximum wattage.

Thirdly, the plates 30, 31 delimit the active volume of the dispensing chamber 13 and the (optionally adjustable) distance between the plates 30, 31 during the filling of the chamber 13 determines the volume of a single portion.

Fourthly, the plates 30, 31 serve to press the dispensing chamber 13 empty after the hot drinking chocolate has been dispensed, so that no hot drinking chocolate remains behind, which is advantageous with regard to bacterial contamination.

The figures do not show that the plates 30, 31 may also be positioned so far apart from one another that the dispensing chamber 13 is able to accommodate a plurality of portions, preferably half the entire volume of the drinking chocolate accommodated in the filled and closed bag 10. This option is particularly advantageous in order for it to be possible to homogenize the contents after a new bag 10 has been placed in the device 1.

To homogenize the contents, there is provision for the closure means 40 to open the channel 14 and then for the plates 20, 21 to push approximately 2.5 litres of drinking chocolate out of the storage chamber 12 into the dispensing chamber 13, after which the closure means 40 close the channel 14. As a result of the plates 20, 21 then being moved apart and the channel 14 being opened, the dispensing chamber 13 runs empty again and the powerful stream results in homogenization of the drinking chocolate. If appropriate, this is repeated a number of times, preferably automatically. It is also possible for the homogenization to be carried out at other times, for example if no drinking chocolate has been dispensed for a certain period or, for example, each morning.

The homogenization of the contents of the bag is also advantageous for other products, such as sauces, soups, baby food or other foodstuffs, and may also take place in a system in which no heat-transfer means are provided, for example for paint.

The homogenization could also be achieved by moving the contents of the bag to and fro between the storage chamber and the dispensing chamber without closing off the connection between these chambers in the meantime.

To allow the homogenization to take place effectively, it is preferable for the dispensing chamber to have a maximum volume which is at least 25% of the product with which the bag has been filled, preferably 50% or more of this filling volume.

As a variant to or in combination with the closure means 40, the system may also be such that the bag is provided with closure means, which are designed to close off the storage chamber and the dispensing chamber from one another. By way of example a nonreturn valve is provided in the channel 14.

Instead of heater elements which are integrated with the plates 30, 31 it is also possible to provide inductive heating of the plates 30, 31.

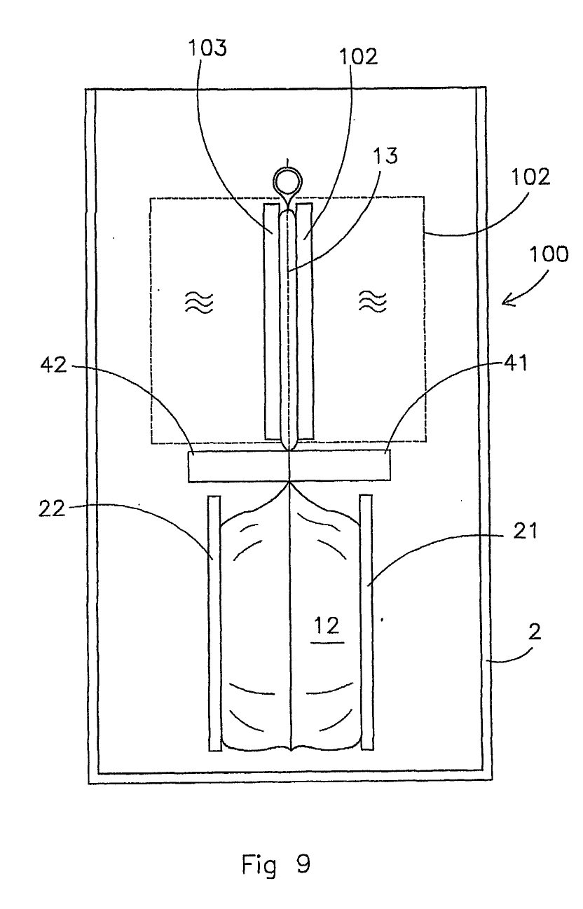

FIG. 9 shows a variant of the device 1, which device 100 has a different way of heating the substance in the dispensing chamber 13. In particular, there is provision for heating by means of microwaves in a shielded compartment 101 of the device 100. To adjust the active volume of the dispensing chamber 13 and/or to allow the chamber 13 to be pressed empty, two plate bodies 102, 103 of microwave-resistant and transmissive material are provided arranged opposite one another. The plates 102, 103 may be arranged in a fixed position, but it is also possible to provide displacement means for varying the distance between the plates 102, 103.

In the examples shown, the drinking chocolate is not cooled in the storage chamber 12. If appropriate, it is possible to provide cooling means for cooling drinking chocolate which is present in the storage chamber of the bag. In this case, it is advantageous for the heating to take place at a higher location, since hot air rises.

The systems shown can be used, for example, to dispense substance at a dispensing temperature of the substance which can be adjusted between 20 and 100° C.

For a foodstuff which is intended for human consumption, such as drinking chocolate, coffee, tea or soup, the temperature is preferably between 60 and 95° C. For foodstuffs for babies and small children, a lower suitable dispensing temperature could be set.

As will be clear, it is also conceivable for the substance in the dispensing chamber not to be heated but rather to be cooled. For this purpose, the plates 30, 31 would be substantially cooled, for example to below freezing. In that case, the dispensing temperature of the substance could be adjusted, for example, between −5 and 15° C.

The dispensing device could be provided with a thermally insulating partition, which is provided with a passage for the bag, between that section of the space into which the dispensing chamber 13 of the bag 10 fits and that section of the space into which the storage chamber 12 of the bag 10 fits.

It will be clear that the system according to the invention is suitable for a very wide range of substances, for example for foodstuffs, in particular perishable foodstuffs, but also for cream, soap, paint, glue products, etc.

After leaving the bag 10, it is possible for an additive to be added to the substance, for example in the dispensing channel 50. By way of example, gas or steam is added to the drinking chocolate in order to obtain optimum foam formation. The additive may change the dispensing temperature of the substance with respect to the temperature at which the substance leaves the dispensing chamber of the bag. By way of example, cold carbon dioxide can be added to the substance. If the substance to be dispensed from the bag is, for example, a syrup, the substance coming out of the dispensing chamber could be mixed with a liquid, for example water.

The channel 50 may also form part of the bag 10, so that the described coupling between the bag and the channel can be dispensed with.

In addition to the body 16 with the dispensing opening 15, the bag 10 may also be provided with a separate filling connection for filling the bag. On the other hand, the filling could also take place via the dispensing opening 15 or via one of the seams, which is subsequently closed.

It will be clear that the bag may also be positioned in a different position in the device, for example with the dispensing chamber at the bottom or in a horizontal position. The dispensing chamber and the storage chamber could also lie next to one another. In a further variant, the system provides, for example, for the presence of a plurality of dispensing chambers in the bag and a single common storage chamber.

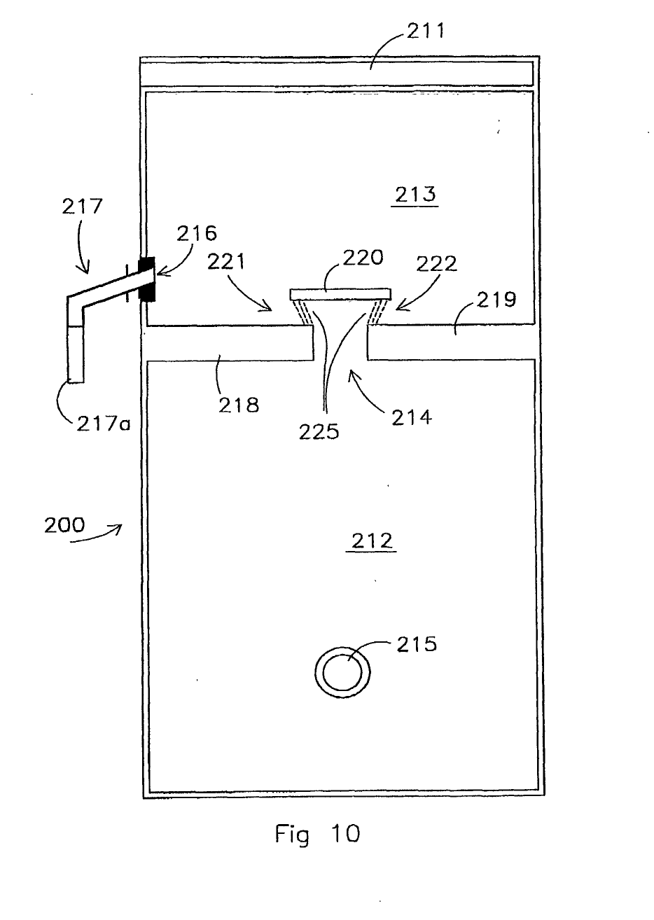

A bag 200 according to the third aspect of the invention will now be explained with reference to FIG. 10. This bag 200 is in this case shown in an embodiment which forms an alternative to the bag 10 described above. However, the bag 200 is also suitable for other applications and can also be designed with different dimensions for still further applications.

In this example, the bag 200 is made from a suitable plastics film, for example polyethylene (PE) or polypropylene (PP), in this example by welding together two layers of film. The material of the bag 200 may also be a laminated material. By way of example, the outermost layer is able to withstand an elevated temperature. It is also possible for the bag to comprise a layer of metallic material, such as aluminium, in order to ensure the gastightness and airtightness.

In this example, the bag 200 is provided with a hanging feature 211, by means of which the bag 200 can be hung in the device 1. The hanging feature 211 in this case comprises an insertion cavity for a hanging rod.

At the bottom, the bag 200 has a storage chamber 212 for accommodating a store of substance, which store comprises a plurality, preferably a large number, of portions.

Furthermore, a dispensing chamber 213, which is connected to the storage chamber 212 via a connection 214 in the bag 200, is delimited in the bag 200.

The storage chamber 212 has a maximum volume which is such that all the substance which is introduced into the bag 200 by the manufacturer, preferably under aseptic conditions, fits into it, after which the bag 200 is closed. By way of example, the bag 200 is filled via a filling spout 215.

The bag 200 is preferably filled with the substance in such a manner that no air is enclosed in the bag.

In this example, the dispensing chamber 213 of the bag 200 has a maximum volume which is a plurality of times greater than the volume of a portion which is to be dispensed. In a variant, the maximum volume of the dispensing chamber 213 is equal to the volume of one portion.

At the dispensing chamber 213, the bag 200 is provided with an outlet opening 216 for dispensing the substance from the bag. In this case, the opening 216 is adjoined by a plastic hose 217, which in this example is securely welded to the bag 200. The end of the hose 217 is closed off by pressing a part 217a of the hose 217 flat and heat-sealing it. The outlet opening in the bag 200 is formed by cutting through the hose 217 above the part 217a which has been welded closed.

The connecting passage 214 is in this case produced by welds 218, 219 which are oriented transversely from each of the vertical side seams of the bag 200, end at a distance from one another and join together the two film layers of the bag 200. The cross-sectional area of the passage 214 is therefore smaller than the cross-sectional area of both the storage chamber 212 and the dispensing chamber 213.

It can be seen from FIG. 10 that the mutually opposite film layers of the bag 200 are also connected to form a barrier 220; in this example, the layers of film around the said barrier 220 are separated from one another. As seen in the direction from the storage chamber 212 towards the dispensing chamber 213, this barrier 220 is situated at a distance from that end of the connecting passage 214 which adjoins the dispensing chamber 213. In this case, therefore, two passage channels 221, 222 are formed between the barrier 220 and the respective welds 218, 219. The transverse dimension of the barrier 220 is greater than the distance between those ends of the welds 218, 219 which face towards one another (i.e. the width of the connecting passage 214 in the flat state). It should be noted that the barrier 220 does not have to be an elongate strip as shown in FIG. 10. As seen in the vertical direction, therefore, the barrier 220 is situated at a distance above the connecting passage 214.

The barrier 220 has two effects, which will be explained below.

If, with the bag 10, substance is pressed out of the storage chamber 12, the dispensing chamber 13 will be completely full after a certain time. At that moment, a type of pressure wave may occur in the substance in the chamber 13, with the result that a (slight) flow of substance back to the storage chamber 12 via the connection 14 may occur within a short time, even before the connecting passage 14 can be pressed closed by means of the closure means 40. This is undesirable for various substances, such as for example drinking chocolate, in particular on account of the risk of contamination to the store in the storage chamber 12.

In the bag 200, the barrier 220 prevents this undesirable backflow. This is because the barrier 220 blocks a direct “vertical” flow out of the dispensing chamber 213 to the chamber 212.

The barrier 220 also entails the effect that folds 225 may form in the region of the two passage channels 221, 222, in such a manner that flow of substance back out of the chamber 213 to the chamber 212 is blocked by these folds 225, where the film layers bear taut against one another. These folds 225 extend approximately between each end of the barrier 220 and the adjacent end of one of the welds 218, 219, as indicated by dashed lines in FIG. 10. These folds 225, which act as a type of nonreturn valve, are formed in particular if the bag 200 is hung in such a manner that the dispensing chamber 213 is vertically above the storage chamber 212. However, it has been found that the closure action of the folds 225 can also be obtained in other positions of the bag 200, such as the horizontal position, in particular when the chamber 213 is full of substance. The barrier 220 may render the closure means 40 of the device 1 superfluous.

The bag 200 with the barrier 220 is conceivable, for example, in an embodiment in which the dispensing chamber 213 is designed to accommodate a single portion of the substance to be dispensed. The bag 200 could be provided with a so-called standing base in the vicinity of the underside of the storage chamber 212, so that the bag 200 can stand stably on its standing base and there is no need for a hanging feature to be present or even for there to be any device whatsoever in which the bag 200 is accommodated. By way of example, in a small design the bag 200 could contain, for example, a quantity of substance which it is desired to meter in small portions, for example sauce for chips, coffee whitener, a concentrated beverage, a colorant, etc. The outlet opening 216 may also be connected to the dispensing chamber 213 at a different location.

What is claimed is:

1. System for providing portions of a substance, in particular a liquid or pasty substance, comprising:
a bag (12;200) for the substance which is to be dispensed, a storage chamber (12;212) for accommodating a store of substance which is to be dispensed being delimited in the bag, which store comprises a plurality of portions, preferably a large number of portions, of the substance which is to be dispensed, and a dispensing chamber (13;213) which can be connected to the storage chamber via a connecting passage (14;214) in the bag also being delimited in the bag, and the bag being provided, at the dispensing chamber, with an outlet opening (16;216) for dispensing the substance from the bag,
a dispensing device (1) which has a housing in which there is a space for accommodating the bag, which space comprises a section for accommodating the storage chamber of the bag and a section for accommodating the dispensing chamber of the bag, the system being designed to supply in each case one or a few portions of the substance to the dispensing chamber from the storage chamber, the dispensing device comprising heat-transfer means for influencing the temperature of the substance in the bag, wherein the dispensing device, at the section of the space inside it which is to accommodate the dispensing chamber of the bag, is provided with heat-transfer means (30,31;102) for influencing the temperature of the substance which is to be dispensed from the dispensing chamber with respect to the temperature at which the substance passes from the storage chamber into the dispensing chamber, which heat-transfer means are designed to supply heat to the substance present in the dispensing chamber of the bag or to extract heat from the substance present in the dispensing chamber of the bag, in such a manner that a portion of substance can be dispensed at a desired temperature from the dispensing chamber.

2. System according to claim 1, in which the dispensing device comprises actuable closure means (40,41,42) which are designed to close off the storage chamber and the dispensing chamber of the bag from one another.

3. System according to claim 1, in which the heat-transfer means comprise one or more heat-transfer bodies (30,31) and associated means for influencing the temperature of each heat-transfer body, each heat-transfer body being designed, in contact with the dispensing chamber of the bag, to effect transfer of heat between the substance in the dispensing chamber and the heat-transfer body.

4. System according to claim 3, in which each heat-transfer body (30,31) is integral with the associated means for influencing the temperature of the heat-transfer body.

5. System according to claim 3, in which a heat-transfer body is made from metal, and in which the dispensing device is preferably provided with induction heating for heating the metal heat-transfer body.

6. System according to claim 3, in which the dispensing device comprises heat-transfer bodies (30,31) which are arranged at a distance from one another, in such a manner that the dispensing chamber of the bag fits between the heat-transfer bodies.

7. System according to claim 6, in which the distance between the heat-transfer bodies (30,31), which are positioned opposite one another, is variable, and in which displacement means (33,34) associated with the heat-transfer bodies (30,31) are preferably provided, for the purpose of varying the distance between the heat-transfer bodies.

8. System according to claim 3, which is such that, if it is desired to dispense a portion of substance, the one or more heat-transfer bodies and the substance-filled dispensing chamber of the bag are placed against one another, so that the substance in the dispensing chamber reaches the desired dispensing temperature and the portion can be dispensed from the dispensing chamber, after which the contact between the heat-transfer body and the bag is eliminated.

9. System according to claim 8, in which the contact between the dispensing chamber of the bag and the one or more heat-transfer bodies is effected by supplying substance to the dispensing chamber from the storage chamber.

10. System according to claim 8, in which the contact between the dispensing chamber of the bag and the one or more heat-transfer bodies is eliminated by dispensing substance from the dispensing chamber via the outlet opening.

11. System according to claim 1, in which the dispensing device comprises actuable compression means, which are designed to compress the dispensing chamber of the bag in order for the substance to be dispensed from the bag.

12. System according to claim 11, in which the compression means comprise compression bodies (30,31) which are arranged at a variable distance from one another, in such a manner that the dispensing chamber of the bag fits between them, and associated displacement means (33,34) for varying the distance between the compression bodies so that the dispensing chamber can be compressed.

13. System according to claim 12, in which at least one of the compression bodies also forms a heat-transfer body.

14. System according to claim 3, in which the one or more heat-transfer bodies have a heat-storage capacity which is such that, at the predetermined, desired temperature of the one or more heat-transfer bodies, a quantity of heat which is required to heat the substance which has been transferred from the storage chamber into the dispensing chamber to a predetermined, desired dispensing temperature of the substance can be exchanged between the substance in the dispensing chamber and the one or more heat-transfer bodies, preferably in such a manner that the substance in the dispensing chamber can be heated to the desired dispensing temperature within at most one minute, particularly preferably within 30 seconds.

15. System according to claim 1, in which the system is designed to move substance which is present in the bag to and fro between the storage chamber and the dispensing chamber one or more times, in order to agitate and homogenize the substance, preferably in such a manner that the connecting passage in the bag, during the homogenization, is closed off each time the dispensing chamber has been filled and is then opened again, so that the substance flows back into the storage chamber in a powerful stream.

16. System according to claim 1, in which the dispensing chamber of the bag has a maximum volume which is greater than the volume of a portion to be dispensed, and in which the dispensing device is provided with volume-adjustment means for adjusting an active volume of the dispensing chamber of the bag.

17. System according to claim 1, in which the maximum volume or an active volume of the dispensing chamber of the bag virtually corresponds to the volume of a portion of the substance which is to be dispensed.

18. System according to claim 1, in which the dispensing device, at the section of the space in the housing which is to accommodate the storage chamber of the bag, is provided with further heat-transfer means, which are designed to keep the substance in the storage chamber at a different temperature from the desired dispensing temperature of the substance.

19. System according to claim 18, in which the further heat-transfer means associated with the storage chamber of the bag are designed as cooling means for cooling substance which is present in the storage chamber of the bag.

20. System according to claim 19, in which the heat-transfer means associated with the dispensing chamber of the bag are designed to heat the substance, and in which the dispensing device is preferably designed to accommodate the bag in a position which is such that the dispensing chamber is situated above the storage chamber.

21. System according to claim 1, in which a dispensing channel, which is or can be connected to the dispensing opening of the bag, is provided, which dispensing channel opens out at a dispensing nozzle.

22. System according to claim 21, in which the dispensing device is provided with an actuable closure means for closing off the dispensing channel at a closure location, the dispensing device preferably being provided with a plurality of actuable closure means which are able to close off the dispensing channel at closure locations which are situated at a distance from one another.

23. System according to claim 21, in which the dispensing device is provided with means for removing residues of the substance from the dispensing channel, in particular from the section between the dispensing nozzle and an adjacent closure location.

24. System according to claim 1, in which the dispensing device is provided with actuable feed-promoting means for promoting the feed of substance from the storage chamber to the dispensing chamber of the bag.

25. System according to claim 1, in which the bag is provided with a connecting passage, formed by one or more channels, between the storage chamber and the dispensing chamber, the cross-sectional area of the connection passage being smaller than the cross-sectional area of both the storage chamber and the dispensing chamber.

26. System according to claim 1, in which the dispensing device is provided with actuable bag-squeezing means which locally squeeze the bag, in such a manner that a storage chamber and a dispensing chamber, as well as a connecting passage which comprises one or more channels between the two chambers, are formed in the bag.

27. System according to claim 1, in which the dispensing device is designed to accommodate the bag in an orientation which is such that the dispensing chamber and the storage chamber are situated above one another, preferably in such a manner that the dispensing chamber is situated above the storage chamber, and in which attachment means are preferably provided for attaching the bag to the housing of the device, for example hanging means for hanging the bag in the dispensing device.

28. System according to claim 1, in which the dispensing device is provided with a thermally insulating separating feature, for example a wall, which is provided with a passage for the bag, between the section of the space into which the dispensing chamber of the bag fits and the section of the space into which the storage chamber of the bag fits.

29. System according to claim 1, in which the bag (200) has two layers of film/foil which are located opposite one another and delimit a storage chamber (212) for accommodating a store of substance which is to be dispensed, which store comprises a plurality, preferably a large number, of portions of the substance which is to be dispensed, and which layers of film/foil furthermore delimit a dispensing chamber (213) and a connecting passage (214) in the bag between the storage chamber and the dispensing chamber, the layers of film/foil of the bag (200) being connected to form a barrier (220) which, as seen in the direction from the storage chamber (212) towards the dispensing chamber (213), is situated at a distance from that end of the connecting passage (214) which adjoins the dispensing chamber (213) and extends transversely to the path of the substance flowing out of the connecting passage (214).

30. Method for operating the system according to claim 3, in which, if no dispensing of substance is desired, the one or more heat-transfer bodies is/are kept at a predetermined temperature, the said body not being in contact with the dispensing chamber of the bag and the dispensing chamber being at least almost empty.

31. Method according to claim 30, in which—if dispensing a portion of heated substance is desired—the dispensing chamber is filled with a portion of substance from the storage chamber, and the dispensing chamber of the bag is brought into contact with the one or more heat-transfer bodies, the thickness of the dispensing chamber preferably being at most 1 centimetre, particular preferably at most 5 millimetres.

32. Method according to claim 30, in which, after a portion of substance has been supplied to the dispensing chamber, the connecting passage between the dispensing chamber and the storage chamber of the bag is closed off.

33. Method for operating the system according to claim 1, in which, after a new bag filled with substance has been placed in the dispensing device, the substance is moved to and fro between the storage chamber and the dispensing chamber of the bag one or more times.

34. Dispensing device for providing portions of a substance, in particular a liquid or pasty substance, which dispensing device comprises a housing in which there is a space for accommodating a bag for the substance which is to be dispensed, which bag is of the type which has a storage chamber for accommodating a store of substance to be dispensed, which store preferably comprises a plurality of portions of the substance to be dispensed, and which bag furthermore has a dispensing chamber which, via a connecting passage in the bag, is in communication with the storage chamber, and which bag, at the dispensing chamber, is provided with an outlet opening for dispensing the substance from the bag, the space in the housing of the dispensing device comprising a section for accommodating the storage chamber of the bag and a section for accommodating the dispensing chamber of the bag, and the dispensing device being designed to supply in each case one or a few portions of the substance from the storage chamber to the dispensing chamber, wherein the dispensing device, at the section of the space inside it which is to accommodate the dispensing chamber of the bag, is provided with heat-transfer means (30,31;102) for influencing the temperature of the substance which is to be dispensed from the dispensing chamber with respect to the temperature at which the substance passes from the storage chamber into the dispensing chamber, which heat-transfer means are designed to supply heat to the substance present in the dispensing chamber of the bag or to extract heat from the substance present in the dispensing chamber of the bag, in such a manner that a portion of substance can be dispensed at a desired temperature from the dispensing chamber.

35. Dispensing device for providing portions of a substance, in particular a liquid or pasty substance, which dispensing device comprises a housing in which there is a space for accommodating a bag for the substance which is to be dispensed, which bag is of the type which has a storage chamber for accommodating a store of substance to be dispensed, which store preferably comprises a plurality of portions of the substance to be dispensed, and which bag furthermore has a dispensing chamber which, via a connecting passage in the bag, is in communication with the storage chamber, and which bag, at the dispensing chamber, is provided with an outlet opening for dispensing the substance from the bag, the space in the housing of the dispensing device comprising a section for accommodating the storage chamber of the bag and a section for accommodating the dispensing chamber of the bag, and the dispensing device being designed to supply in each case one or a few portions of the substance from the storage chamber to the dispensing chamber, wherein the dispensing device is designed to move the substance to and fro, preferably at least after a new bag filled with substance has been placed in the dispensing device, one or more times between the storage chamber and the dispensing chamber of the bag, in order to agitate and homogenize the substance.

36. Bag for accommodating a liquid or pasty substance, which bag (200) has two walls which are situated opposite one another and delimit a storage chamber (212) for accommodating a store of substance which is to be dispensed, which store comprises a plurality, preferably a large number, of portions of the substance to be dispensed, and which walls furthermore delimit a dispensing chamber (213) and a connecting passage (214) in the bag between the storage chamber and the dispensing chamber, wherein the mutually opposite walls of the bag (200) are locally connected to form a barrier (220) which, as seen in the direction from the storage chamber (212) towards the dispensing chamber (213), is situated at a distance from that end of the connecting passage (214) which adjoins the dispensing chamber (213) and extends transversely to the path of the substance flowing out of the connecting passage (214).
